(19) United States
(12) Patent Application Publication
(10) Pub. No.: US 2022/0256340 A1
(43) Pub. Date: Aug. 11, 2022

(54) METHOD FOR PROVIDING ROAMING SERVICE BY USING BLOCKCHAIN AND APPARATUS THEREFOR

(71) Applicant: HFR,INC, Seongnam-si, Gyeonggi-do (KR)

(72) Inventors: Jong Heon LEE, Seongnam-si (KR); Jong Min CHEONG, Seoul (KR)

(73) Assignee: HER, INC, Seongnam-si, Gyeonggi-do (KR)

(21) Appl. No.: 17/430,814

(22) PCT Filed: Nov. 22, 2019
(86) PCT No.: PCT/KR2019/016128

§ 371 Date: Apr. 12, 2022

(30) Foreign Application Priority Data
Jan. 8, 2019 (KR) 10-2019-0002204
May 29, 2019 (KR) 10-2019-0063408
Nov. 22, 2019 (KR) 10-2019-0151137

(51) Int. Cl. H04W 12/06; H04W 16/14; H04L 9/00; H04L 9/32; H04W 4/50; H04W 12/10; H04W 8/18; H04W 60/00

(52) U.S. Cl. CPC H04W 12/06; H04W 16/14; H04L 9/50; H04W 60/00; H04W 4/50; H04W 12/10; H04W 8/18; H04L 9/3213

(57) ABSTRACT

The present disclosure in some embodiments relates to a method and an apparatus for providing a roaming service, which more efficiently processes internetwork roaming services and settlements between different mobile communication network operators by using a blockchain and a smart contract.

### TECHNICAL FIELD

The present disclosure in some embodiments relates to a method of providing a roaming service by using the blockchain and an apparatus therefor. More particularly, the present disclosure relates to a method of providing a roaming service and an apparatus for the same, which enables efficient handling of roaming services and settlements between different operators' mobile communication networks by using a blockchain and a smart contract.

### BACKGROUND

The statements in this section merely provide background information related to the present disclosure and do not necessarily constitute prior art.

With the evolution of mobile communication services, innovative revolutions are expected in the business composition among telecommunication service providers toward increased frequency usage efficiency, reduced costs of network construction and operation, and promptly introducing and optimizing various services. In tandem with the existing unlicensed bands, various types of spectrum sharing systems are expected to come to the realization and herald a large number of small local mobile network operators (MNOs) to appear. The telecommunication industry further predicts network sharing to thrive among small-scale (or local) MNOs as well as the established MNOs.

Providing an interconnection service, that is, a roaming service for subscribers is the prerequisite to network sharing between MNOs. Such roaming is performed according to agreements and network interworking between MNOs, requiring complex and time-consuming processes such as negotiation of agreement conditions including service level, network interworking test, and settlement among other factors.

In particular, with an increasing number of small-scale MNOs, the number of roaming participants significantly increases, which requires an efficient processing method. For example, when there are n MNOs including small MNOs, up to (n×(n−1))/2 roaming agreements are required, along with the same number of network interworking tests, and quality control and settlement sessions, which will negate the very object of cost reduction by network sharing.

### DISCLOSURE

### Technical Problem

The present disclosure in some embodiments seeks to provide a means for more efficiently processing roaming and settlements between different mobile communication network operators by using a blockchain and a smart contract.

### Technical Solution

At least one aspect of the present disclosure provides a roaming service system, comprising: one or more service nodes configured to generate and store on a blockchain a smart contract related to a roaming service between a home mobile network operator (HNO) and a visited mobile network operator (VNO), and to perform a function for automatically executing the smart contract by using the blockchain; a VNO node configured to provide the roaming service to a user equipment unit (UE) subscribed to the HNO agreed upon based on the smart contract, and to charge a service fee to the HNO for the roaming service as provided; and an HNO node configured to pay the service fee to the VNO node based on the blockchain and the smart contract.

Another aspect of the present disclosure provides a method performed by a roaming service system for providing a roaming service, the method comprising: generating and storing, by one or more service nodes, on a blockchain a smart contract related to the roaming service between a home mobile network operator (HNO) and a visited mobile network operator (VNO); providing, by a VNO node, the roaming service to a user equipment unit (UE) relevant to the HNO agreed upon based on the smart contract, and charging a service fee for using the roaming service; and paying, by an HNO node, the service fee to the VNO node based on the blockchain and the smart contract.

Yet another aspect of the present disclosure provides a computer program recorded on a computer-readable medium and including codes for causing, when executed in at least one processor, the processor to perform steps comprising: generating and storing, by one or more service nodes, on a blockchain a smart contract related to the roaming service between a home mobile network operator (HNO) and a visited mobile network operator (VNO); providing, by a VNO node, the roaming service to a user equipment unit (UE) relevant to the HNO agreed upon based on the smart contract, and charging a service fee for using the roaming service; and paying, by an HNO node, the service fee to the VNO node based on the blockchain and the smart contract.

### Advantageous Effects

According to embodiments of the present disclosure, the means of the present disclosure can more efficiently process the roaming and settlements between different mobile communication network operators by using a blockchain and a smart contract.

### BRIEF DESCRIPTION OF THE DRAWINGS

FIG. 1 is a diagram of the configuration for explaining a roaming service system according to at least one embodiment of the present disclosure.

FIG. 2 is a conceptual diagram for explaining a roaming service scenario in a blockchain network according to at least one embodiment of the present disclosure.

FIG. 3 is a conceptual diagram for explaining an authentication and access control method for a roaming service according to at least one embodiment of the present disclosure.

FIG. 4 is a flowchart for explaining a method of providing a roaming service according to at least one embodiment of the present disclosure.

FIGS. 5 and 6 are example diagrams for explaining a form of implementation of a roaming service system according to at least one embodiment of the present disclosure.

### DETAILED DESCRIPTION

Hereinafter, some embodiments of the present disclosure will be described in detail with reference to the accompanying drawings.

A blockchain is an electronic ledger implemented by a computer-based distributed system composed of blocks each made up of transactions. Each transaction includes at least one input and at least one output. The blocks are linked together so that the relevant blocks, each containing the hash of the previous block, generate a permanent and immutable record of all transactions written to the blockchain from the beginning.

A smart contract is a computer program designed to automate the execution of the terms of a contract or agreement. Unlike traditional contracts written in natural language, smart contracts are machine-executable programs that contain rules that can process inputs to produce results, from which actions can be triggered to be performed.

The present disclosure presents a roaming service-providing method using such a blockchain and a smart contract. More specifically, the present disclosure provides a roaming service structure that enables more efficient network roaming and settlement between different mobile network operators through the use of a blockchain and a smart contract.

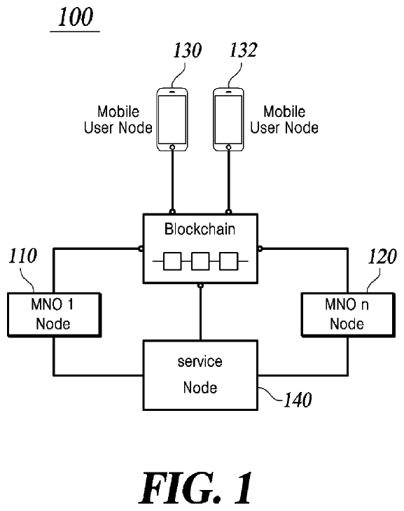

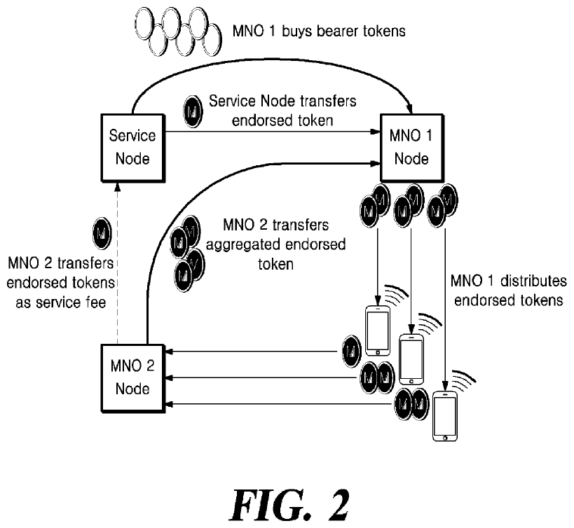

FIG. 1 is a diagram of the configuration for explaining a roaming service system according to at least one embodiment of the present disclosure, and FIG. 2 is a conceptual diagram for explaining a roaming service scenario in a blockchain network according to at least one embodiment of the present disclosure.

Hereinafter, with reference to FIGS. 1 and 2 together, the roaming service system according to at least one embodiment of the present disclosure will be described.

The roaming service system 100 according to at least one embodiment includes n MNO nodes 110, 120 constituting a blockchain network, mobile user nodes or user equipment nodes 130, 132 corresponding to their respective MNOs, and a single or a plurality of service nodes 140. In this case, components included in the roaming service system according to at least one embodiment of the present disclosure are not necessarily limited to these particulars. For example, in roaming service systems, it should be recognized that varying types of services may decide the types of nodes constituting the blockchain network with appropriate configurations of more or fewer components or different components than those as illustrated. In particular, the roaming service system 100 in some embodiments is implemented with an HNO (home mobile network operator) node or a VNO (visited mobile network operator) node performing as a service node without involving a separate service node.

Meanwhile, in at least one embodiment, the respective nodes constituting the blockchain network of the roaming service system are implemented by a program in a computing device. For example, each node may be implemented in the computing device by a Decentralized Application (DApp) which is a kind of decentralized software application.

With such a DApp, the present disclosure provides a function that allows participants to see the ledger in the blockchain, input necessary data, and transmit and receive tokens, etc. Additionally, the present disclosure can provide various functions that enable support of effective services that provide convenience and efficiency in businesses using a blockchain.

On the other hand, in the following description of the roaming service system 100 according to at least one embodiment, the first MNO node 110 is a node equivalent to a home mobile network operator, which will be described hereinafter as an HNO node 110, and the second MNO node 120 is a node equivalent to a visited mobile network operator, which will be described hereinafter as a VNO node 110.

The HNO node 110 is a blockchain network node equivalent to the home mobile network operator, and provides various functions related to roaming service use and settlement of the user equipment (UE) subscribed to the home mobile network operator.

In the present disclosure, the HNO node 110 may perform the settlement of the roaming service usage by the UE based on the blockchain and smart contract. In other words, the HNO node 110 operates for allowing transaction processing to be performed based on tokens depending on the UE's use of the roaming service.

To this end, the HNO node 110 may buy or generate tokens (e.g., Bearer tokens) in advance, and distribute them to a UE or a user. For example, the HNO node 110 may purchase tokens issued from the service node 140 and distribute them to a UE or a user as a service use right for the roaming service.

In this case, the HNO node 110 may perform an endorsement or registration process for the purchased tokens, and transmit the endorsed or registered tokens to the blockchain account opened to the UE or user. Here, the registration means to pay legal currency or the commensurate cryptocurrency for the later recovered tokens under the contract.

On the other hand, the HNO node 110 mainly supports the roaming service to the subscribed UEs under the smart contract, but it may operate to support the roaming service to some or all of the UEs according to the preset service provision policy.

For example, the HNO node 110 may be responsive to when the preset service provision policy intends to provide a service to select subscribers for performing authentication therefor, and accordingly distribute registered tokens for the roaming service to the select UEs or users.

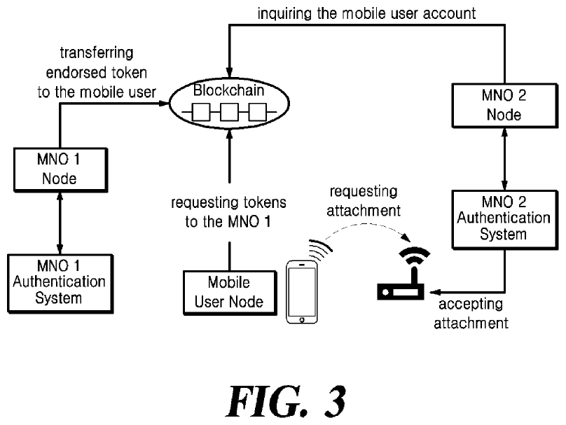

As shown in FIG. 3, the HNO node 110 may have a unique authentication system that interworks with the HNO node 110 and thereby perform authentication of a UE or a user. On the other hand, when a UE that is a subscriber to the HNO installs the DApp therein, the DApp automatically requests the HNO node 110 for the endorsed tokens. The HNO node 110 performs authentication by accessing its authentication system including a policy server, and accordingly transfers the endorsed tokens to the UE or the user's account.

In such a method, the HNO is very efficient because it only needs to render its authentication system to interwork with its HNO node 110. Additionally, access control for supporting the roaming service is performed according to the service policy of the HNO node 110, and the VNO node 120, having no knowledge of the user's identity information, causes no additional privacy issues.

Thereafter, the HNO node 110 and the VNO node 120 utilize the above tokens in calculating the service fee commensurate with to usage of the roaming service by the UE or the user. In other words, the HNO node 110 receives a certain amount of token from the VNO node 120 as proof of a service fee depending on the UE's or the user's roaming service use. In this case, the certain amount of token may be tokens equivalent to an amount converted in proportion to the service usage and quality of the roaming service for the UE. Meanwhile, the VNO node 120 may receive the tokens from the UE or the user in return for using the roaming service.

The HNO node 110 pays legal currency equivalent to the amount of token received or cryptocurrency, e.g., stablecoins equivalent to that legal currency to the VNO node 120.

On the other hand, the HNO node 110 may reuse the tokens received from the VNO node 120 and distribute them to UEs or users, and through this process, the tokens may be repeatedly circulated. Additionally, when the scale of the service grows and the circulated tokens are insufficient, the HNO node 110 may buy and distribute additional tokens.

The VNO node 120 is a blockchain network node equivalent to a visited mobile network operator, and it provides functions such as the establishment and management of a visited mobile network.

The VNO node 120 provides a roaming service according to an agreement with a mobile network operator with subscribers. In the present disclosure, the VNO node 120 provides the roaming service exclusively to the mobile users or user equipments (UEs) that subscribed to a mobile network operator agreed to by using a blockchain and a smart contract.

To this end, the VNO node 120 may identify the contractual mobile network operators UE among the UEs located within the visited mobile network coverage, and perform access control on the UE. The present disclosure allows the VNO node 120 to identify the contractual mobile network operator's UE among those located within the mobile network coverage under the smart contract stored in the blockchain.

As shown in FIG. 3, the VNO node 120 may receive roaming request signals including connection request information and account information from UEs, and may use the roaming request signals as the basis for identifying the UEs in relation to providing a roaming service. For example, the VNO node 120 may check the parameters for permission confirmation on the connection request information, e.g., the UE owners' public keys, International Mobile Subscriber Identities (IMSIs), Globally Unique Temporary Identifiers (GUTIs), and the like, based on which the VNO node 120 may identify the UEs of the contractual mobile network operator.

Additionally, the VNO node 120 may identify the UEs that are subject to the roaming service from a limited circle of UEs or users holding a certain amount of tokens or more in the account based on the account information.

The VNO node 120 checks whether an executable roaming service contract exists between the HNO and the VNO, identified in the smart contract, and accordingly performs the credential check on the user or UE whether it has the roaming service use right.

The VNO node 120 is provided with a result of credential check on whether the UE or user is authorized to use the roaming service, and it accordingly transmits a credential response to the UE for the same to use the visited mobile.

Thereafter, the VNO node 120 aggregates service usage information from the UE that used the roaming service, and transmits a payment request for the service to the HNO 110 node. Meanwhile, in at least one embodiment of the present disclosure, the service usage information of the UE includes, but is not limited to, utility tokens equivalent to an amount converted in proportion to the service usage and quality of the roaming service. Accordingly, the VNO node 120 may transfer the converted amount of tokens to the HNO 110 node to charge a service fee related to the roaming service.

The VNO node 120 may be provided with the legal currency equivalent to the tokens, which is transferred, from the HNO 110 node or cryptocurrency, e.g., stablecoins equivalent to that much legal currency.

The UE nodes 130 and 132 are blockchain network nodes equivalent to mobile users using the roaming service, and provide functions such as access, service usage information transmission, and the like depending on the roaming service.

In the present disclosure, the UE nodes 130 and 132 may receive tokens in relation to the use of the roaming service in advance from the MNO node of the mobile network operator to which the UE is subscribed.

Accordingly, the UE nodes 130 and 132 may measure the service usage amount and quality information according to the use of the roaming service, and may provide the VNO node 120 with the converted amount of the utility tokens in proportion to the measurement as the service usage information.

The service node 140 performs functions necessary to operate the blockchain and the blockchain network.

In the present disclosure, the service node 140 performs a function to enable efficient contract conclusion between the HNO and the VNO on the roaming service and automatic execution thereof.

For example, the service node 140 converts an agreement, when concluded into a contract in natural language by the parties of HNO and VNO, into an automatically executable smart contract.

Additionally, the service node 140 verifies the integrity of the smart contract and network key performance indicator (KPI) data.

Further, the service node 140 provides various services for the operation of the blockchain, including transaction verification.

The following details the function of the service node 140.

The service node 140 according to at least one embodiment of the present disclosure generates and stores on the blockchain (or distributed ledger) a smart contract related to a roaming service between a home mobile network operator and a visited mobile network operator.

The service node 140 first utilizes a standard contract or service level agreement (SLA) expressed in natural language as a basis for arranging the home mobile network operator and the visited mobile network operator to adjust/settle on negotiable conditions with each other. Here, the contents and conditions of the standard contract may be implemented as an optional combination of predefined phrases or sentences specific to the business field.

The service node 140 converts the concluded contract content into executable software on a blockchain or blockchain network through a rule engine such as artificial intelligence (AI) to generate a smart contract (e.g. executable codes).

The service node 140 performs non-repudiation on the smart contract by using the respective digital signatures of the home mobile network operator and the visited mobile network operator, and stores the processed smart contract on the blockchain. This immediately guarantees the integrity of the information on the agreement concluded between the HNO and the VNO.

The service node 140 functions to automatically execute the smart contract by utilizing the blockchain. To this end, the service node 140 may function to verify the integrity of -roaming service related events occurring from or on offchain. In the present disclosure, the service node 140 performs functions such as securing the reliability of a transaction, providing the integrity of N/W performance data, and controlling N/W access by using a blockchain. For example, the service node 140 issues token commensurate with the roaming service, and verifies the integrity of transaction events related to the roaming service that occur based on the tokens.

The service node 140 performs verification by comparing the service usage information measured from the UE with the service provision information measured from the VNO node 120, and stores, on the blockchain, the service usage information that completed the verification.

The service node 140 compares the measured KPI data for the UE from the VNO node 120 with the amount of utility token transferred from the UE, and if the difference is less than a predetermined threshold, it determines that the service usage information is completely verified.

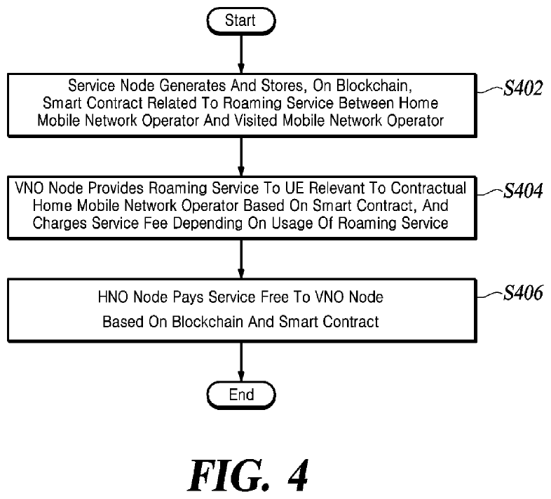

FIG. 4 is a flowchart for explaining a method of providing a roaming service according to at least one embodiment of the present disclosure.

The service node 140 generates and stores on the blockchain a smart contract related to a roaming service between a home mobile network operator and a visited mobile network operator (S402). In Step S402, the service node 140 converts the contents of the contract concluded based on the standard contract or service level agreement expressed in natural language between the home mobile network operator and the visited mobile network operator into a software executable on the blockchain or blockchain network and thereby generates the smart contract.

The VNO node 120 provides a roaming service to the UE relevant to the contractual home mobile network operator under the smart contract of Step S402, and charges a service fee depending on the use of the roaming service (S404). In Step S404, the VNO node 120 receives a roaming request signal including connection request information and account information from the UE, and performs access control over the UE based on the service provision policy based on the account information and based on the blockchain.

The VNO node 120 receives from the UE a converted amount of tokens in proportion to the service usage and quality for the roaming service as service usage information, and transfers the converted amount of tokens to the HNO node 110 to charge a service fee.

The HNO node 110 aggregates service usage information for the UE from the VNO node 120, and pays a fee commensurate with the service usage information to the VNO node 120 based on the blockchain and smart contract (S406). In Step S406, the HNO node 110 receives utility tokens transferred as service usage information for the UE from the VNO node 120, and pays the VNO node 120 with the legal currency equivalent to the utility tokens or a cryptocurrency, e.g., stablecoins equivalent to the legal currency.

Here, since Steps S402 to S404 correspond respectively to the operation of the components of the roaming service system 100 described above, no further description is provided.

Although the steps in FIG. 4 are described to be sequentially performed, they merely instantiate the technical idea of some embodiments of the present disclosure. In line with this, a person having ordinary skill in the pertinent art could perform the steps by changing the sequences described in FIG. 4 or by performing two or more of the steps in parallel, and hence the steps in FIG. 4 are not limited to the illustrated chronological sequences.

As described above, the method of providing a service by the roaming service system described in FIG. 4 may be implemented as a program and recorded to be computer-readable on a recording medium (CD-ROM, RAM, ROM, memory card, hard disk, optical/magnetic disk, storage devices, and the like) by way of computer software.

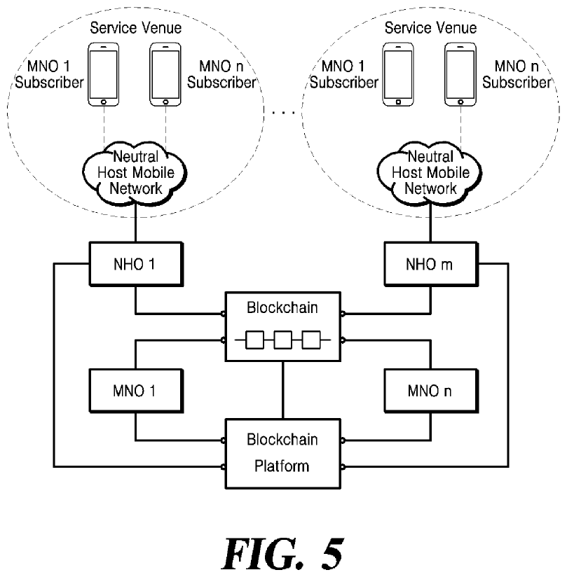

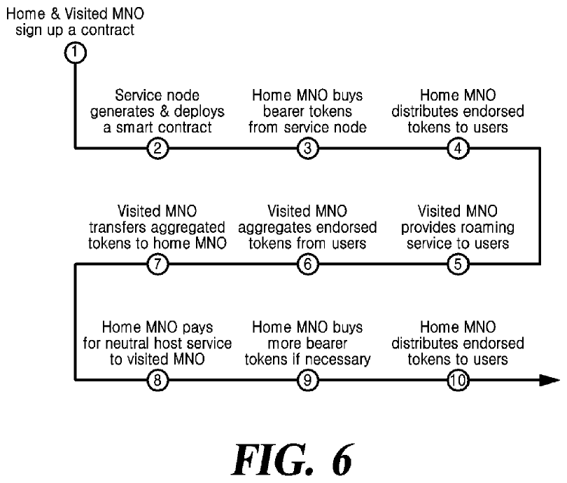

FIGS. 5 and 6 are example diagrams for explaining a form of implementation of a roaming service system according to at least one embodiment of the present disclosure.

In the present disclosure, the roaming service system 100 may be implemented in the form of a neutral host network service model when an MNO 2, which is a visited mobile network operator, does not directly recruit subscribers but provides services to subscribers of other home mobile network operators.

As shown in FIG. 5, neutral host network service operators or neutral host operators (hereinafter, NHOs) establish a mobile communication network and/or Wi-Fi network and provide services to subscribers to the contractual MNOs, and the MNOs pay the NHOs for the services. Meanwhile, in the neutral host network service model, the NHO may function as a VNO and the MNO may function as an HNO. In other words, the neutral host network service model is a specific example in which the roaming service system 100 is implemented, and its access control and settlement method for roaming may apply the same.

An example of a roaming service and settlement procedure in such a service model is shown in FIG. 6.

\textcircled{1}, \textcircled{2} The service node 140 generates a smart contract related to a roaming service between a home mobile network operator and a visited mobile network operator, and stores the generated smart contract on a blockchain.

\textcircled{3}, \textcircled{4} HNO node 110 buys bearer tokens from the service node 140, registers the tokens, and then distributes the endorsed tokens to UE or user accounts relevant to the home mobile network operator.

\textcircled{5}, \textcircled{6}, \textcircled{7} The VNO node 120 provides the roaming service to the UEs, and receives tokens transferred commensurate with the quantity and quality of the roaming service from the UEs or users.

\textcircled{8}, \textcircled{9}, \textcircled{10} The HNO node 110 is provided with a certain amount of tokens from the VNO node 120 as proof of service fee depending on the roaming service usage by the UE, and pays the VNO node 120 with the legal currency equivalent to the provided tokens or a cryptocurrency, e.g., stablecoins equivalent to the legal currency.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

### REFERENCE NUMERALS

| | |
|---|---|
| 100: roaming service system | 110: HNO node |
| 120: VNO node | 130, 132: user equipment node |
| 140: service node | |

### CROSS-REFERENCE TO RELATED APPLICATION

This application claims priority under 35 U.S.C. § 119(a) of Patent Application No. 10-2019-0002204, filed on Jan. 8, 2019, Patent Application No. 10-2019-0063408, filed on May 29, 2019, and Patent Application No. 10-2019-0151137, filed on Nov. 22, 2019 in Korea, the entire contents of which are incorporated herein by reference. Additionally, this non-provisional application claims priority in countries, other than the U.S., with the same reason based on the Korean patent application, the entire content of which is hereby incorporated by reference.

1. A roaming service system, comprising:
one or more service nodes configured to generate and store on a blockchain a smart contract related to a roaming service between a home mobile network operator (HNO) and a visited mobile network operator (VNO), to issue tokens commensurate with the roaming service, and to verify an integrity of transaction events related to the roaming service and occurring based on the tokens;
a VNO node configured to provide the roaming service to a user equipment (UE) subscribed to the HNO agreed upon based on the smart contract, and to charge a service fee to the HNO for the roaming service as provided; and
an HNO node configured to pay the service fee to the VNO node based on the blockchain and the smart contract.

2. The roaming service system of claim 1, wherein the service node is configured to generate the smart contract by converting contents of a contract concluded based on a standard contract or service level agreement (SLA) expressed in natural language between the HNO and the VNO into software executable on a blockchain or blockchain network.

3. (canceled)

4. The roaming service system of claim 1, wherein the HNO node is configured to distribute the tokens issued from the service node commensurate with the roaming service to a blockchain account assigned to the UE or a user as rights to use the roaming service.

5. The roaming service system of claim 4, wherein the HNO node is configured to process an endorsement or registration on the tokens upon receiving the tokens for a fee or free of charge from the service node, and to transmit endorsed tokens to the blockchain account assigned to the UE or the user.

6. The roaming service system of claim 4, wherein the HNO has an authentication system unique to the HNO and interworking with the HNO node, and is configured to perform authentication through the authentication system for the UE that requests a connection service to the VNO network, and
wherein the HNO node is configured to transfer the tokens to the blockchain account of the UE or the user according to the authentication as performed.

7. The roaming service system of claim 4, wherein the HNO has a unique authentication system including a policy server interworking with the HNO node, and is configured to periodically distribute, selectively according to a service policy of the HNO, a certain amount of the tokens to the blockchain account assigned to the UE or the user.

8. The roaming service system of claim 4, wherein the HNO is configured to receive a request to make a token transfer manually or automatically from the UE or the user, to perform authentication by using an authentication system and a policy server that are linked with the HNO, and to transfer a commensurate amount of the tokens to the blockchain account of the UE or the user.

9. The roaming service system of claim 1, wherein the VNO node is configured to receive a roaming request including connection request information and account information from the UE and to perform access control on the UE based on the blockchain and a service provision policy that is based on the account information.

10. The roaming service system of claim 9, wherein the VNO node is configured to allow the UE or a user in possession of a blockchain account containing a certain amount of tokens or more to exclusively access the roaming service.

11. The roaming service system of claim 10, wherein the VNO node is configured to receive service usage information for the roaming service based on the tokens from the UE, and to charge the service fee according to the service usage information.

12. The roaming service system of claim 11, wherein the VNO node is configured to receive, as the service usage information, tokens equivalent to an amount converted in proportion to service usage and quality of the roaming service, and to charge the service fee by transferring, to the HNO node, the tokens of the amount converted.

13. The roaming service system of claim 1, wherein the VNO alone concludes smart contracts with multiples of the HNO and provides the roaming service to subscribers to multiple HNOs.

14. The roaming service system of claim 1, wherein the VNO node or the HNO node functions as the service node.

15. A method performed by a roaming service system for providing a roaming service, the method comprising:
generating and storing, by one or more service nodes, on a blockchain a smart contract related to the roaming service between a home mobile network operator (HNO) and a visited mobile network operator (VNO);
distributing, by the HNO node, the tokens issued from the service node commensurate with the roaming service to a blockchain account assigned to the UE or a user as rights to use the roaming service;
providing, by a VNO node, the roaming service to a user equipment (UE) relevant to the HNO agreed upon based on the smart contract, and charging a service fee for using the roaming service; and
paying, by an HNO node, the service fee to the VNO node based on the blockchain and the smart contract,
wherein the service node verify an integrity of transaction events related to the roaming service and occurring based on the tokens.

16. (canceled)
